(19) United States
(12) Patent Application Publication
(10) Pub. No.: US 2005/0102870 A1
(43) Pub. Date: May 19, 2005

(54) Display electronic label

(76) Inventors: Philippe Catteau, Neuilly Sur Seine (FR); Thierry Petri, Mundolsheim (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/495,829

(22) PCT Filed: Nov. 13, 2002
(86) PCT No.: PCT/FR02/03875

(30) Foreign Application Priority Data
Nov. 13, 2001 (FR) 01/14636

(51) Int. Cl. G09F 3/04

(52) U.S. Cl. 40/450

(57) ABSTRACT

The invention concerns a display (1), in particular for an electronic label for a price display system in a store, comprising at least a price display zone (7, 8, 9) including two figure displaying elements (15, 16, 17) of decreasing ranks to form a whole number. The invention is characterized in that at least part of a figure of higher rank has at least a dimension smaller than the corresponding dimension of the figure of lower rank in accordance with a ratio.

The invention concerns electronic labels intended in particular for price display systems in hypermarket type stores.

The main object of price display systems is to make it possible, at the shelves of a site such as a hypermarket, supermarket or any other sales area (for example a pharmacy, etc.), to present to the customers, for each item for sale, a price which it is known will correspond accurately to the price as it appears in the central file of the store, that is to say the price as will actually be used at the till for payment for the item. Moreover, such systems make it possible to carry out automated price changes within much shorter times than with a manual display, whether for particular promotion periods in the store, for all or some of the items, to reflect price list changes, to meet inflation situations where the prices have to be increased very frequently, etc.

Furthermore, as regards price display, there are many constraints, in particular legal ones, regarding the nature of the prices displayed (unit price, promotional price, etc.) which must be complied with by electronic systems in the same way as by paper labels. Thus electronic labels, although they are tending to become increasingly sophisticated, remain however relatively inflexible as regards the various display possibilities and as regards the organisation time-wise of these various possibilities.

Electronic labels, such as those described in the document FR-2802693, allow many display possibilities in order to comply with the previously mentioned legal constraints with a flexible and fast update. However, such labels can prove difficult for the customer to read, on account of the considerable amount of information to be displayed.

Certainly, in order to save space, in the label of the aforementioned document in particular, resorting to smaller figures for designating the figures of the price situated after the decimal point is known, in order to thus either reduce the total space requirement of the liquid crystal display area of the label or, with an equal space requirement, increase the display possibilities or the readability of the display in the remaining areas of the label.

One aim of the invention is to provide a display device for an electronic label making it possible to go even further in this process, that is to say either reduce the overall size of the display without impairing the readability, or improve the readability or the display possibilities for a given display size.

For that, there is provided, according to the invention, a display device, in particular for an electronic label for a price display system in a store, comprising at least one price display area comprising at least two figure displaying elements of decreasing ranks intended to form an integer, characterised in that at least part of a figure of higher rank has at least one dimension smaller than the corresponding dimension of a figure of lower rank according to a ratio.

Thus, the most commonly used figures can be seen clearly by the customer (like, for example, for prices in euros, the centimes, the euros, perhaps even the tens of euros, which make it possible to display the price of over 95% of the items in a hypermarket), whilst the least commonly used figures (like, in the present example, the hundreds, the thousands of euros, etc.) are more unobtrusive and occupy a reduced display device surface area. This makes it possible to optimise as much as possible the layout of the display areas of the electronic label without degrading its readability by a customer or the amount of information displayed.

Advantageously, the display device also has at least one of the following optional characteristics:
said dimension is the overall width of the figure displaying element;
each figure displaying element comprises superposed left-hand vertical segments and superposed right-hand vertical segments, and in that said dimension is the width of the left-hand segments;
each figure displaying element comprises horizontal segments extending between left-hand and right-hand generally vertical segments, and in that said dimension is the length of the horizontal segments;
the figure displaying elements form the integer part of a main price display area of the display area;
the ratio is between 0.4 and 1;
the ratio is between 0.65 and 0.95;
the display area comprises at least three figure displaying elements of decreasing rank intended to form an integer;
the display area comprises at least four figure displaying elements of decreasing rank intended to form an integer; and
the display device comprises three price display areas.

There is also provided, according to the invention, an electronic label, in particular for a price display system in a store, comprising a display device having at least one of the aforementioned characteristics.

Other characteristics, aims and advantages of the invention will emerge more clearly from the following description of two embodiments and variants. In the accompanying drawings:

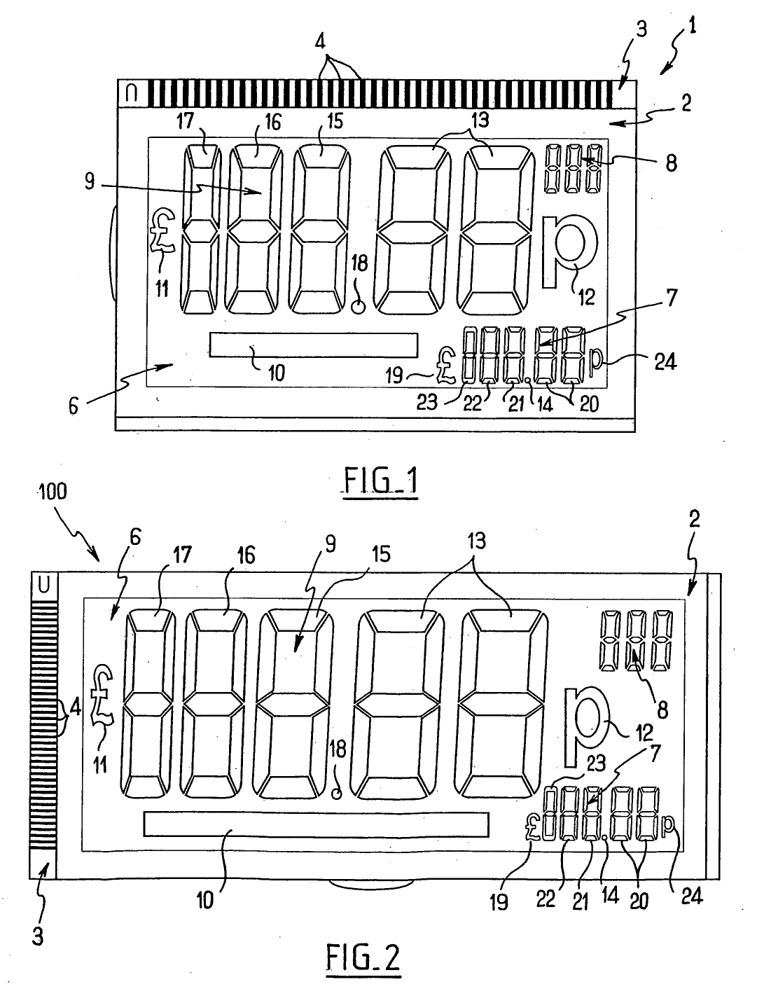

FIG. 1 is a layout diagram of a display device for an electronic label according to a first embodiment of the invention;

FIG. 2 is a layout diagram in a variant of the display device of FIG. 1;

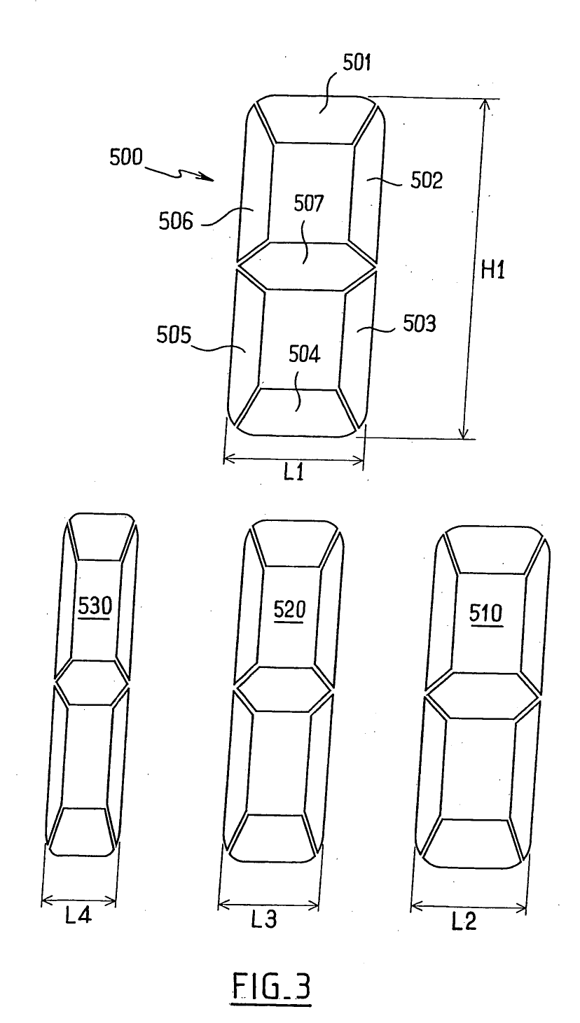

FIG. 3 is a diagram depicting the successive figure displaying elements of a display area of the display device of FIG. 1;

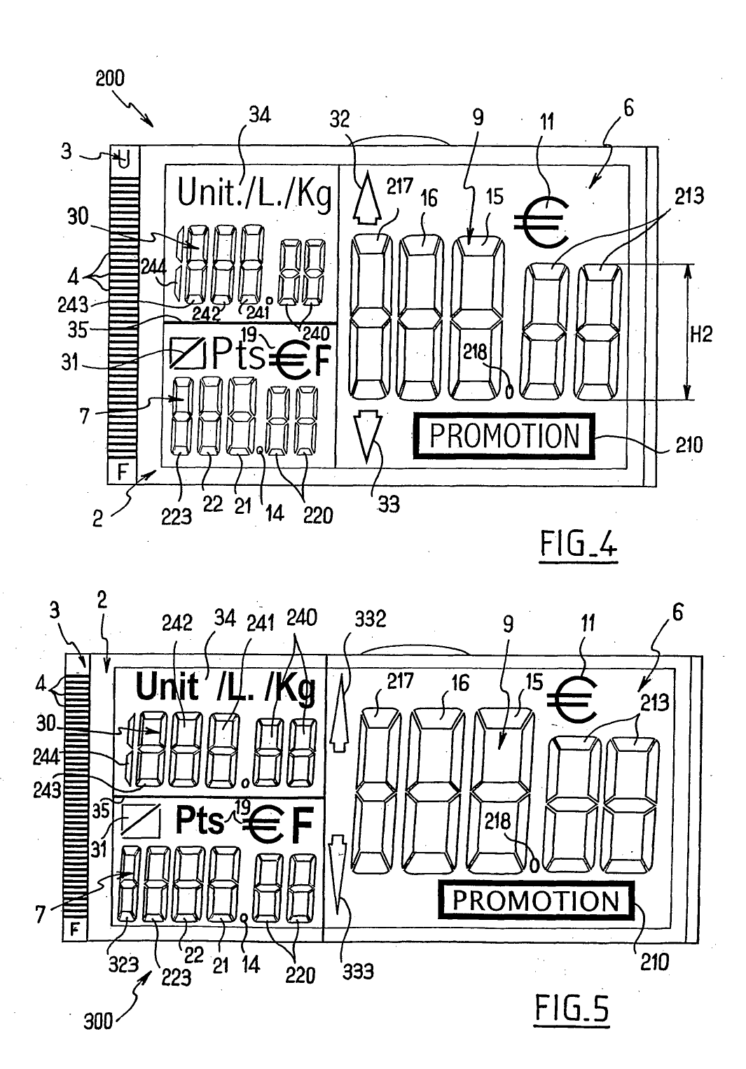

FIG. 4 is a layout diagram of a display device for an electronic label according to a second embodiment of the invention;

FIG. 5 is a layout diagram in a variant of the display device of FIG. 4; and

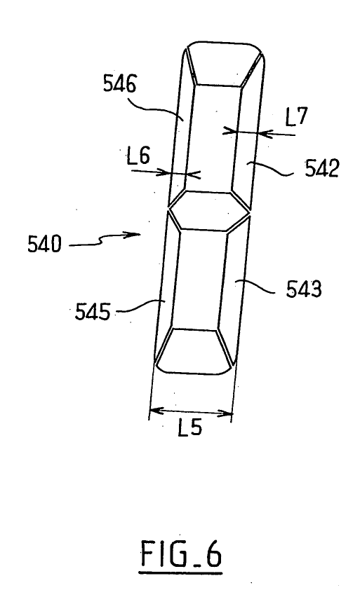

FIG. 6 is a diagram depicting one of the figure displaying elements of the display device of FIG. 4.

With reference to FIG. 1, the first embodiment of a display device 1 for an electronic label will be described. This display device consists of at least one plate 2, preferably made of glass, on one side of which there are positioned connection means 3 extending so as to protrude, here from the upper side of the plate 2. The connection means 3 have a series of conductive strips 4 capable of implementing an electrical connection between the display device and the electronic label device (not depicted) into which the display device 1 comes to be plugged in. One face of the plate 2 comprises display means 6 which can be preferentially of liquid crystal display (LCD) type, the technology of which is known per se. The display means 2 have several display areas 7, 8 and 9, here three in number.

The first display area 7 comprises a pictogram 19 representing preferentially a currency symbol of a country where the electronic label is used. Here, the pictogram corresponds to the United Kingdom pound sterling (£). Next, the first display area has three figure displaying elements 21, 22 and 23 constituting the integer part of the price capable of being displayed in the display area 7, and then a point 14 separating the integer part from a decimal part of the price constituted by two figure displaying elements 20. Finally, a second pictogram 24 completes the display area 7. Here, the pictogram 24 represents the penny (p) which is one hundredth of the pound sterling.

The second display area 8 here comprises a series of three figure displaying elements having an identical display matrix. This display area is intended to present any information whatsoever consisting of figures.

The third display area 9 is similar to the first display area 7. The main difference between the two display areas is the dimensions of the information presented which are larger in the third display area 9 than in the first display area 7. The display area 9 is intended to display the price of the item as presented for sale on the shelf of the gondola where said electronic label is placed. Therefore, the display area 9 comprises:
a pictogram 11 representing here a currency symbol identical to that presented by the pictogram 19;
a first series of three figure displaying elements 15, 16 and 17 constituting the integer part of the price;
a separation point 18;
a second series of two figure displaying elements 13 constituting the decimal part of the price; and
a second pictogram 12 similar in its form to the pictogram 24.

Under the third display area 9, the display device 6 has a pictogram 10, here in the form of an elongated bar. This pictogram 10, partly underlining the price displayed in the area 9, makes it possible to attract the attention of customers in order to indicate to them a special price such as a promotional price.

Each figure displaying element of each display area consists of seven segments 501 to 507, as illustrated by the typical figure displaying elements in FIG. 3. Each segment is in the form of an elongated bar, the ends of which end with a single bevel, as for the segments 501 to 506, or with a double bevel like the segment 507. Two segments 502 and 503 form a left-hand column, two segments 505 and 506 form a right-hand column, and the last three segments 501, 504 and 507 connect respectively the upper tips, the lower tips and the middles of the two right-hand and left-hand columns. During operation of the display device 6 of the label, each of the segments 501 to 507 is in either an on (or 1) state or an off (or 0) state. Thus, the different figures, from 0 to 9, are displayed by considering the state of the seven segments 501 to 507 in a manner perfectly known per se. For each of the preceding display areas, the figure displaying element which will act as the origin for dimensioning the other figure displaying elements of the display area under consideration is similar to the typical figure displaying element 500 of FIG. 3: it has a height H1 and a width L1. The typical figure displaying element 510 has the same height H1 and a width L2 less than or approximately equal to L1. Similarly, the typical figure displaying element 520 has an identical height H1 and a width L3 less than or approximately equal to L2. And, similarly, the typical figure displaying element 530 has an equal height H1 and a width L4 less than or approximately equal to L3. Thus this gives: L4≦L3≦L2≦L1.

In the case of the first display area 7, the figure displaying elements 20 are similar to the typical figure displaying element 500: they have a height H1 and a width L1. The figure displaying element 21 is similar to the typical figure displaying element 510 and has a width L2=0.89*L1. The figure displaying element 22 is similar to the typical figure displaying element 520 and has a width L3=0.84*L1≈0.94*L2. The figure displaying element 23 is similar to the typical figure displaying element 530 and has a width L4=0.63*L1=0.75*L3.

In the case of the second display area 8, the three figure displaying elements are identical to one another and are similar to the typical figure displaying element 500.

In the case of the third display area 9, according to a reasoning similar to that used for the first display area, the figure displaying elements 13 are similar to the typical figure displaying element 500: they have a height H1 and a width L1. The figure displaying element 15, similar to the typical figure displaying element 510, has a width L2=0.83*L1. The figure displaying element 16, similar to the typical figure displaying element 520, has a width L3=0.73*L1≈0.88*L2. The figure displaying element 17, similar to the typical figure displaying element 530, has a width L4.=0.52*L1≈0.71*L3.

With reference to FIG. 2, a variant implementation 100 of the display device 1 for an electronic label will be described. The display device 100 is very similar to the display device 1. The disposition of the different display areas on the display means 6 is slightly different with an increased surface area for the third display area 9. The disposition, within the different display areas, of the pictograms and/or the figure displaying elements is identical. Moreover, the connection means 3 extend so as to protrude from the left-hand side of the plate 2 of the display device for an electronic label 100.

In the display area 7 of the electronic label, if it is considered that the figure displaying elements 20 similar to the typical figure displaying element 500 have a width L1 and a height H1:
the figure displaying element 21 has a width L2=0.90*L1;
the figure displaying element 22 has a width L3=0.75*L1≈0.83*L2;
the figure displaying element 23 has a width L4=0.60*L1=0.80*L3.

Similarly, in the display area 9, if it is considered that the figure displaying elements 13 have a height H1 and a width L1:
the figure displaying element 15 has a width L2=0.85*L1;
the figure displaying element 16 has a width L3=0.70*L1≈0.82*L2;
the figure displaying element 17 has a width L4=0.56*L1=0.80*L3.

The main advantage of this display device structure is to allow optimum visibility and readability of the most commonly displayed figures. This is because, for prices in pounds sterling for example, the figure displaying elements for the tens or hundreds are used less often than the price displaying element for the units: approximately 75% of items in a hypermarket cost less than £10 and only approximately 2% cost more than £100. Therefore, when the figure displaying element for the hundreds is used, it is most often a “1”, that is the left-hand column of the price displaying element.

The detailed description of a second embodiment of the invention according to FIG. 4 and of a variant of this second embodiment according to FIG. 5 will now be given.

The display device for an electronic label 200 is in the form of a plate 2 and comprises connection means 3 extending so as to protrude from the left-hand side of said plate. Moreover, one face of the plate 2 comprises display means 6 of LCD type. As previously, the display device 200 comprises several display areas 7, 9 and 30, here also three in number.

The display area 9 constitutes the main area and occupies more than the right-hand half of the total surface of the display means 6. As for the display devices 1 and 100, this display area comprises a first series of figure displaying elements 15, 16 and 217, here three in number, a separation point 218, and then a second series of figure displaying elements 213, here two in number. The first series of figure displaying elements constitutes the integer part of the price displayed in the area and the second series of figure displaying elements constitutes the decimal part of said price. Again, the figure displaying elements are formed by seven segments as described previously. Vertically in line with and above the figure displaying element following the separation point, the display area 9 comprises a pictogram 11 which here represents the Euro symbol, the single currency of the Euro Zone of the European Community. Moreover, the display area 9 comprises vertically in line with the figure displaying element 217, above and below, a pictogram 32, 33 representing an arrow pointing either upwards 32, or downwards 33. These two arrows allow the location of the item for which the area 9 is displaying the price, the item possibly being on the shelf bearing the label or underneath. Finally, a pictogram 210 is capable of partly underlining the price displayed in the area. This pictogram makes it possible to signal a promotional price to the customer.

The figure displaying element 15 is similar to the typical figure displaying element 500 and has a height H1 and a width L1. The figure displaying element 16 is similar to the typical figure displaying element 510: it has the same height as the figure displaying element 15 and a width L2=0.88*L1. The figure displaying element 217 is similar to the typical figure displaying element 540 illustrated in FIG. 6 and described below. The figure displaying element 217 has a height H1 and a width L5≈0.86*L2.

The typical figure displaying element 540, illustrated in FIG. 6, comprises a right-hand column consisting of two segments 542 and 543 having a width L7. It also comprises a left-hand column formed from two segments 545 and 546 having a width L6 which is less than or approximately equal to L7. In the present case, L6≈0.82*L7.

The figure displaying elements 213 forming the decimal part of the price to be displayed are of similar form to the typical figure displaying element 500. They have however a height H2 less than or approximately equal to the height H1 of the figure displaying element 15 for the units. Similarly, the figure displaying elements 13 have a width less than or approximately equal to the width L1 of the figure displaying element 15 for the units. The reduction factor is here of the order of 0.80.

The two display areas 7 and 30 occupy the remaining left-hand part of the display means 6. The upper half of this left-hand part is occupied by the display area 30 and the lower part is occupied by the display area 7. The two display areas are separated by a bar 35.

The display area 30 comprises a series of four figure displaying elements 241, 242, 243, 244 forming the integer part of the price to be displayed, a separation point and a series of two figure displaying elements 240 forming the decimal part. Above these figure displaying elements, the display area 30 comprises a pictogram 34 capable of displaying, as desired, the type of price indicated by the figure displaying elements of the area: “Unit.” for a price per unit, “/L.” for a price per litre, “/Kg” for a price per kilo. As for the display area 7, this comprises a series of three figure displaying elements 21, 22, 223 forming an integer part, a separation point 14, and then a second series of two figure displaying elements 220 forming a decimal part. Above, the area 7 comprises a first pictogram 31, and then a second pictogram 19 capable of representing a currency symbol such as here pesetas (“Pts”, Spain), [symbol] ros or francs (“F”, France or Belgium, etc.). This area can display a conversion into another currency of the price displayed in the area 7. Preferentially, the pictogram “Pts” can be used to indicate that the number displayed in the display area 7 indicates the number of loyalty points the customer can receive for the purchase of the item under consideration by the electronic label.

As previously, the figure displaying elements of these two areas are based on the typical figure displaying elements of FIGS. 3 and 6.

As regards the area 30, the figure displaying element 241 is the basic figure displaying element having a height H1 and a width L1 similar to the typical figure displaying element 500. The figure displaying element 242 is identical to the figure displaying element 241. The figure displaying element 243 is similar to the typical figure displaying element 540 and has a width L5≈0.91*L1. The figure displaying element 244 uses only the segments forming the right-hand column of the figure displaying element 243 without changing the dimensions thereof. The figure displaying elements 240 have a height H2 and a width less than or approximately equal to the height H1 and the width L1 respectively of the figure displaying element 241. Here, the reduction factor is of the order of 0.82.

As regards the area 7, the figure displaying element 21 is the basic figure displaying element having a height H1 and a width L1 similar to the typical figure displaying element 500. The figure displaying element 22 has a width L2=0.95*L1. The figure displaying element 223 is similar to the typical figure displaying element 540 and has a width L5≈0.91*L1. The figure displaying elements 220 have a height H2 and a width less than or approximately equal to the height H1 and the width L1 respectively of the figure displaying element 21. Here, the reduction factor is of the order of 0.8.

In a variant 300 of the display device for an electronic label 200 illustrated in FIG. 5, only the differences thereof will be described. The overall size of the display areas is greater as is that of the figure displaying elements present in these areas.

The display area 9 comprises pictograms 332 and 333 in the form of arrows situated to the left of the figure displaying element 217. The display area 7 has an additional figure displaying element 323 to the left of the figure displaying element 223.

From the proportions point of view, for the display area 7, if the figure displaying element 15 has a height H1 and a width L1:
the figure displaying element 16 has a width L2=0.95*L1;
the figure displaying element 217, similar to the typical figure displaying element 540, has a width L5≈0.69*L2;
the figure displaying elements 213 have a height and a width of the order of 0.77 times H1 and L1 respectively.

For the display area 30, if the figure displaying element 241 has a height H1 and a width L1:
the figure displaying element 242 has a width L2=0.97*L1;
the figure displaying element 243, similar to the typical figure displaying element 540, has a width L5≈0.78*L2;
the figure displaying element 244 comprises two segments in a column which are identical to the segments of the right-hand column of the FIG. 243;
the figure displaying elements 240 have a height and a width of the order of 0.8 times H1 and L1 respectively.

Finally, for the display area 7, if the figure displaying element 21 has a height H1 and a width L1:
the figure displaying element 22 has a width L2=0.91*L1;
the figure displaying element 223, similar to the typical figure displaying element 540, has a width L5≈0.85*L2;
the figure displaying element 323, similar to the typical figure displaying element 540, has a width approximately ≈0.82*L5;
the figure displaying elements 220 have a height and a width of the order of 0.8 times H1 and L1 respectively.

Of course, many modifications can be made to these embodiments without departing from the scope of the invention.

In particular, the different embodiments described above and shown in the drawings can be combined with one another in various ways.

Moreover, persons skilled in the art will know how to make the necessary adaptations according in particular to the currency or currencies to be taken into account and the typical prices of the items according to the kind of store.

1. A display device (1; 100; 200; 300), in particular for an electronic label for a price display system in a store, comprising at least one price display area (7, 8, 9; 30) comprising at least two figure displaying elements (15, 16, 17; 21, 22, 23; 217; 241, 242, 243, 244; 223; 323) of decreasing ranks intended to form an integer, characterised in that at least part of a figure of higher rank has at least one dimension smaller than the corresponding dimension of a figure of lower rank according to a ratio.

2. A display device according to claim 1, characterised in that said dimension is the overall width of the figure displaying element (L1, L2, L3, L4, L5).

3. A display device according to claim 1 or claim 2, characterised in that each figure displaying element comprises superposed left-hand vertical segments and superposed right-hand vertical segments, and in that said dimension is the width (L6, L7) of the left-hand segments.

4. A display device according to claim 3, characterised in that each figure displaying element comprises horizontal segments extending between left-hand and right-hand generally vertical segments, and in that said dimension is the length of the horizontal segments.

5. A display device according to claim 1, characterised in that the figure displaying elements form the integer part of a main price display area of the display area.

6. A display device according to claim 1, characterised in that the ratio is between 0.4 and 1.

7. A display device according to claim 1, characterised in that the display area comprises three figure displaying elements of decreasing rank intended to form an integer.

8. A display device according to claim 1, characterised in that the display area comprises four figure displaying elements of decreasing rank intended to form an integer.

9. A display device according to claim 1, characterised in that it comprises three price display areas.

10. An electronic label, in particular for a price display system in a store, characterised in that it comprises a display device according to claim 1.
